(19) United States
(12) Patent Application Publication
(10) Pub. No.: US 2004/0267629 A1
(43) Pub. Date: Dec. 30, 2004

(54) Purchasing hub for a procurement system

(76) Inventors: Karina Herrmann, Heidelberg (DE); Nelson Capetillo, Wiesloch (DE); Peter Fitz, Waldsee (DE); Ruediger Mueller, Wiesloch (DE); Alexander Zaichenko, Hockenheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/610,326

(22) Filed: Jun. 30, 2003

(51) Int. Cl. G06F 17/60

(52) U.S. Cl. 705/26

(57) ABSTRACT

Techniques are disclosed for procuring items using a central computer system in a distributed network of computer systems. In one general aspect, the invention provides for receiving, at a central computer system, a first purchase request for a first item to be procured. The first purchase request is received from a first computer system in a network of computer systems and includes a first item category identifier that describes the first item. A second computer system in the network is selected based on the first item category identifier so that a purchase document may be created in the second computer system. The creation of the purchase document in the second computer system is controlled by the central computer system.

### TECHNICAL FIELD

The description relates to computer-implemented procurement systems.

### BACKGROUND

Companies utilize computer-implemented procurement systems to receive and process purchase requests for items, such as goods or services. One example of a computer-implemented procurement system uses a central purchasing computer, where all or certain purchase requests are sent to be processed. The purchase requests may be created on the central purchasing computer or on remote company computer systems.

A purchasing application executing on the central purchasing computer receives the requests for items to be purchased from suppliers. A user operating the purchasing application can view incoming requests, search for appropriate suppliers to fill the requests, and create purchase orders for the items. The purchase orders can then be printed and mailed, or electronically submitted, to the suppliers, who may then ship the ordered items. Such a procurement system may be adequate for companies where all of the business units within the company utilize the same buying systems.

In the present-day corporate environment, however, companies frequently merge with other companies, are acquired by outside companies, or restructure their operations by combining or separating business units within the company. This can lead to disparate procurement systems that are incompatible with one another within the resulting company. Moreover, potential efficiencies such as searching for suitable suppliers across procurement systems and combining purchase requests from various procurement systems may not be possible. As such, conventional computer-implemented procurement systems tend to be limited in flexibility and/or functionality.

### SUMMARY

The invention provides techniques for procuring items using a central computer system. In one general aspect, the invention provides for receiving, at a central computer system, a first purchase request for a first item to be procured. The first purchase request is received from a first computer system in a network of computer systems and includes a first item category identifier that describes the first item. A second computer system in the network is selected based on the first item category identifier so that a purchase document may be created in the second computer system. The creation of the purchase document in the second computer system is controlled by the central computer system.

Implementations may include one or more of the following. The second computer system may be selected by referencing an item category list that contains a collection of item category identifiers and a corresponding computer system for each item category identifier. The first item category identifier may be located in the item category list and the corresponding computer system may be identified. The second computer system may be selected without user intervention. Alternatively, a user may manually select the second computer system. The purchase document may be a purchase order for the first item, or a contract for the first item. The first item may be a good or a service. The second computer system may be different from the first computer system.

In some embodiments, a supplier may be identified to fulfill the first purchase request. This may involve searching supply source repositories located on a collection of computer systems in the distributed network of computer systems. Alternatively, the first purchase request may identify a suggested supplier to fulfill the first purchase request. In this case, the second computer system may be the same as the first computer system.

In another aspect, the purchase document may be a bidding document for the first item, and a group of suppliers may be invited to participate in an auction whereby the suppliers bid to source the first item. Each of the suppliers may be associated with one of the computer systems in the network of computer systems, and selecting the second computer system may involve identifying a supplier using results from the auction and selecting the associated computer system.

The first purchase request may also include a procurement criterion that is a directive for the item procurement process, and wherein the selection of the second computer system is based on the procurement criterion. The procurement criterion may be selected from a group consisting of “Always Source Requirement,” “Never Source Requirement,” and “Create a Bidding Document if No Source of Supply is Available in the System.”

In other embodiments, a second purchase request may be received for a second item to be procured. The second purchase request may be received from a third computer system in the network and include a second item category identifier that describes the second item. The selection of the second computer system may be based on the first item category identifier and the second item category identifier so that the purchase document may be created in the second computer system. The purchase document may be a purchase order for the first and second items.

Advantages of the invention may include one or more of the following. A new level of procurement convenience and efficiency is possible. For example, a procurement system incorporating the invention is, in some respects, more flexible and powerful, and as such, may be suitable for applications where a procurement system lacking the invention would be unsuitable. Because the invention may widen the array of potential supply sources, and do so without user interaction, better pricing, reduced costs, increased speed, and fewer errors caused by manual user intervention may result. By combining purchase requests from multiple systems, the business may qualify for preferred pricing due to higher volume orders.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system that may utilize aspects of the invention;

FIG. 2 is a block diagram of a central computer system having a purchasing hub application in accordance with an embodiment of the invention;

FIG. 3 is an illustrative depiction of the purchasing hub application from FIG. 2;

FIG. 4 is an illustrative depiction of a purchase request in accordance with an embodiment of the invention; and

FIGS. 5-6 are exemplary flowcharts illustrating examples of how the purchasing hub application of FIGS. 2-3 may operate.

Like reference symbols in the various drawings indicate like elements.

### DETAILED DESCRIPTION

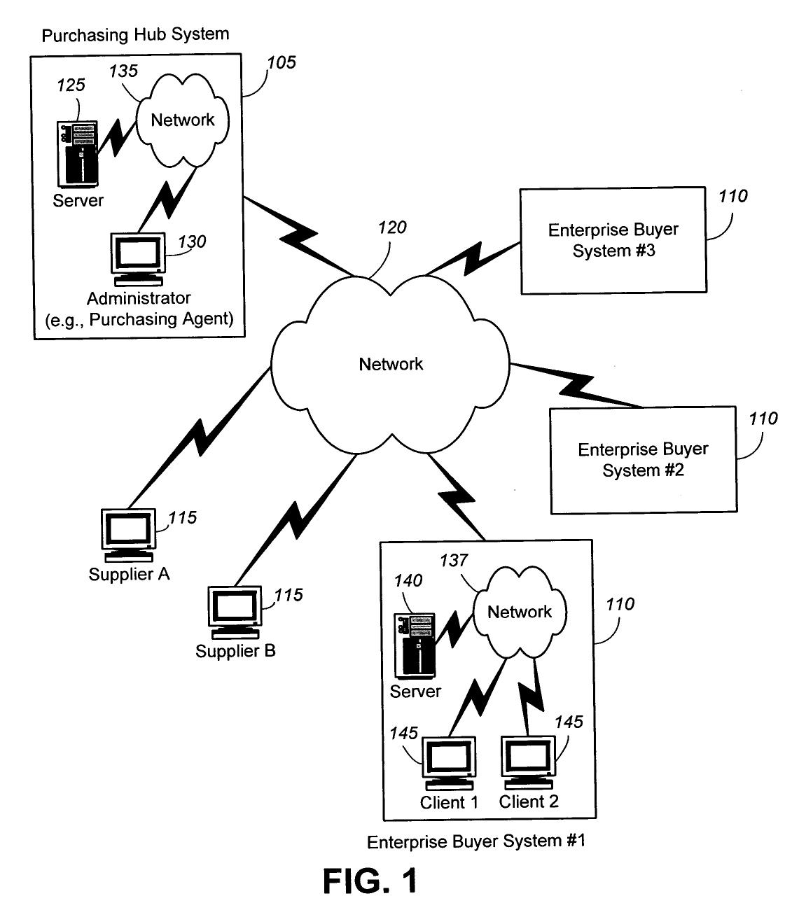

A business's purchasing department may need to procure a wide variety of products and/or services to meet the needs of the business. FIG. 1 illustrates a purchasing hub system 105, enterprise buyer systems 110, and supplier sites 115 which may communicate over a network 120, such as the Internet. The purchasing hub system 105 serves as a control center for procurement operations.

The purchasing hub system 105 includes a purchasing hub server 125 and an administrator site 130. Administrator site 130 may include a computer system, such as a personal computer, terminal, handheld computing device, etc., from which a purchasing administrator may control and execute procurement activities for the business. The purchasing administrator may be a human operator interacting with software running on the computer system, an automated software process executing without human intervention, or various combinations of both. The purchasing hub server 125 and administrator site 130 may communicate over a network 135, such as a local area network, wide area network, intranet, or the Internet. As is conventional, the administrator site 130 may access the purchasing hub server 125 to run applications residing on the server 125.

Similarly, each enterprise buyer system 110 can include a server 140 and client computer systems 145 which may communicate over a network 137. The enterprise buyer systems (EBS's) 110 may individually procure items from suppliers that are known (that is, for which supplier information is available) locally to the individual EBS 110, or may utilize the purchasing hub system 105 to expand their procurement options. For example, a potential purchaser of goods and/or services may create a purchase request for an item at an EBS client computer system 145. The purchase request may be transmitted over network 137 and/or network 120 to the purchasing hub system 105, where it is received and processed.

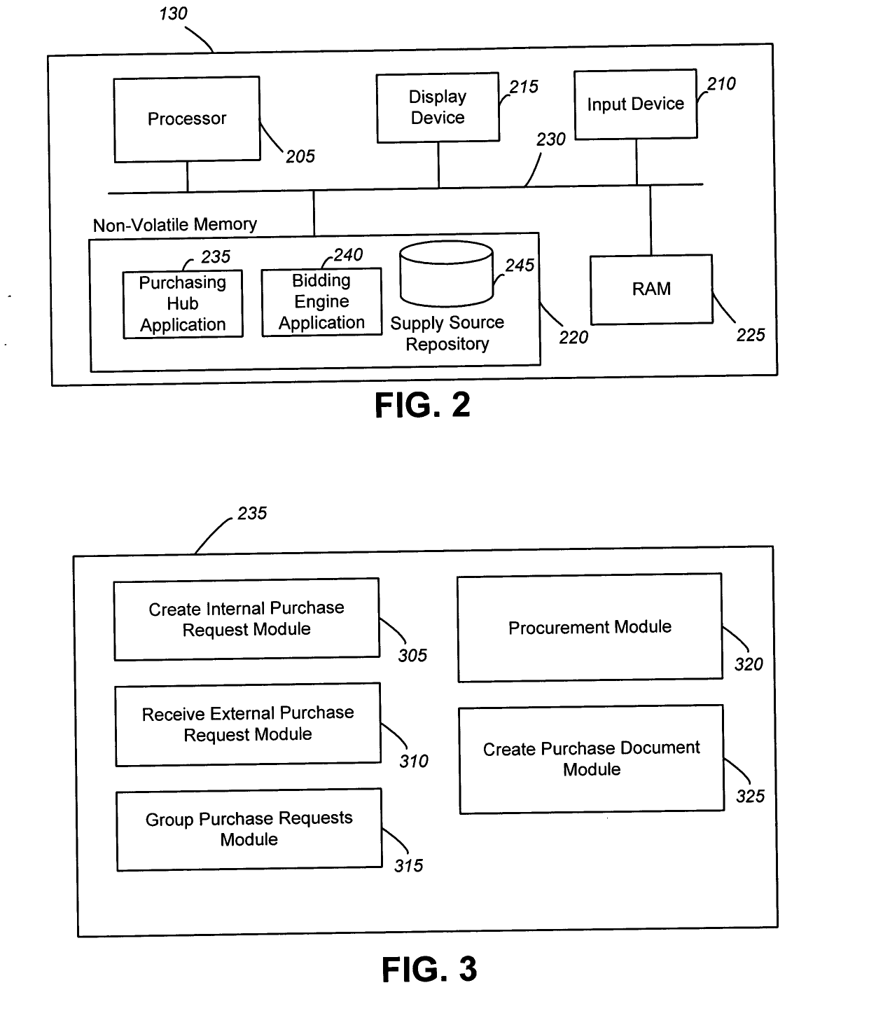

The purchasing hub system 105 may then initiate a procurement process, wherein a suitable source of supply (such as a supplier represented by a supplier site 115, for example) is identified (by a purchasing hub application 235, shown in FIG. 2 and discussed below) to fulfill the purchase request, and an appropriate system (such as systems 105 or 110) is selected (also by purchasing hub application 235) for the creation of a purchase document thereon. The system 105 or 110 may be selected, for example, because it is the system wherein the suitable source of supply is known. Alternatively, the selected system 105 or 110 may be the system from which the purchase request originated.

Next, the purchasing hub system 105 can create the purchase document on the selected system 105 or 110 (again, over networks 135, 137 and 120 as required), the pertinent supplier 115 can be contacted, and a transaction can be completed. Purchasing hub system 105 may additionally contain other client computer systems (not shown), from which purchase requests may be generated and wherein purchase documents may be created. EBS systems #1, #2 and #3 110 may be buying systems for various business units, divisions, or groups within the company, and need not necessarily be similar systems. For example, each may have previously been the respective buying system for independent companies that were acquired by the present company, and which continue to be used following the acquisitions. This may facilitate a smooth transition and minimize expenses during the acquisition by obviating the need for the acquired company to abandon their existing buying system for the system of the acquiring company.

The administrator site 130 may be a client computer system such as that depicted in FIG. 2. The system can include a processor 205, one or more input devices 210, and a display device 215, whereon a user may be presented displays. As is conventional, processor 205 executes computer application program instructions and controls the devices in the computer system. The programs may initially be stored in non-volatile memory 220, such as ROM, including magnetic disk memory, removable non-volatile storage media, and the like. As is conventional, application program instructions may be loaded to RAM 225, thereafter to be executed by processor 205 to perform particular application functions. A bus 230 facilitates communication between the processor 205 and the various devices attached to the bus 230.

Non-volatile memory 220 includes a purchasing hub application 235. The purchasing hub application 235 can manage a company's procurement operations, including creating purchase requests, receiving purchase requests from EBS's 110, grouping purchase requests and determining appropriate sources of supply, selecting appropriate systems in which to create purchase documents and creating the documents therein, and initiating auctions. Examples of such purchase documents include a purchase order for an item, or items, from a supplier, a contract detailing an agreement with a supplier to supply goods or services, and a bidding document to initiate an auction, whereby potential suppliers may bid to supply items.

Purchase orders may specify a one-time purchase of items, whereas contracts may specify longer-term procurement arrangements, e.g., an agreement to purchase fifty items from a supplier at a specific price each month for a year. The purchasing hub application 235 can be used to find the best source of supply for a given purchase request and an appropriate system on which to create the purchase document, and may do so without user interaction, if so desired. By utilizing aspects of the purchasing hub application 235, the purchasing hub system 105 becomes a single access point for all procurement-relevant information throughout the business.

In one implementation, the purchasing hub application 235 is made up of several different application program modules, some of which reside on a central computer system, such as administrator site 130, while others reside on a central server, such as purchasing hub server 125. Purchasing hub functions typically generate and require access to a large amount of data that is stored in various databases on a client or server. The data can include product and service information, supplier and vendor information, and rebate, discount, and preferred pricing information, to list just a few examples. In other implementations, the purchasing hub application 235 can reside entirely on the administrator site 130, or entirely on the purchasing hub server 125.

Referring again to FIG. 2, non-volatile memory 220 further includes a bidding engine application 240 and a supply source repository 245. The bidding engine application 240 may work in concert with the purchasing hub application 235 to facilitate auctions (including reverse auctions) allowing potential suppliers to bid for the right to fulfill purchase requests by supplying a requested good or service at the bid price. In a reverse auction, potential suppliers (such as suppliers represented by supplier sites 115) bid to supply items according to a bid-down principle where the price descends during the auction and the lowest bid is the winning bid. A reverse auction can provide purchasers with significant cost savings by better leveraging competition among suppliers.

The supply source repository 245 contains a list of suppliers that the purchasing hub application 235 can identify to fulfill purchase requests, as well as a list of item category identifiers (discussed below). The supply source repository 245 can contain, for example, approved supplier lists, evaluations of supplier performance, historical procurement information (such as purchasing histories), lists of other business partners, and information on potential new suppliers. The purchasing hub application 235 may access the supply source repository 245 to search for a suitable supplier and select an appropriate system on which to create a purchase document. The supply source repository 245 may be “built-up” during an installation phase, and may subsequently be updated by the purchasing hub application 235, e.g., with information on new suppliers, changes to existing suppliers, or ratings on supplier performance. Following the creation of a purchase document, the purchasing hub application 235 may also update the repository 245 with transaction-relevant information.

A user can use an input device 210, such as a mouse, keyboard, trackball, stylus, joystick, etc., to provide input and make selections (such as from a drop-down box) that can affect application program operation. I/O devices such as a printer (not shown) can be used to print results. Devices such as display controllers, memory controllers, I/O controllers, network adapters, power supplies, etc., are omitted for clarity. The components described with regard to FIG. 2 could be combined or separated in various manners. Any of the entities described above in non-volatile memory 220 could alternatively be located in a separate server, database, or computer system, and could be stored on various non-volatile storage medium.

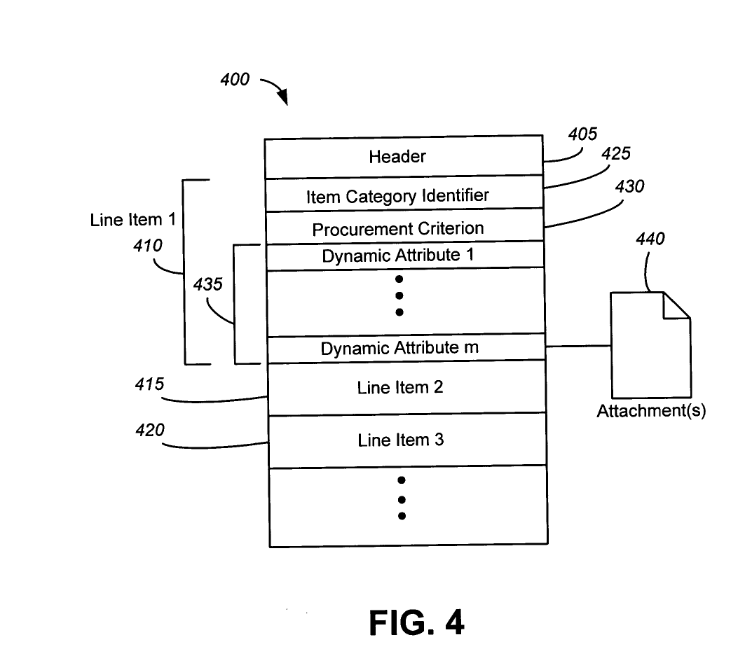

FIG. 3 shows the purchasing hub application 235 of FIG. 2, which is composed of several modules. A create internal purchase request module 305 permits a user to create a purchase request for goods and/or services. The purchase request may be considered “internal” if created at purchasing hub system 105. A receive external purchase request module 310 receives external purchase requests from EBS's 110, which requests are “external” because they originate from systems external to purchasing hub system 105 (for example, EBS #1 110).

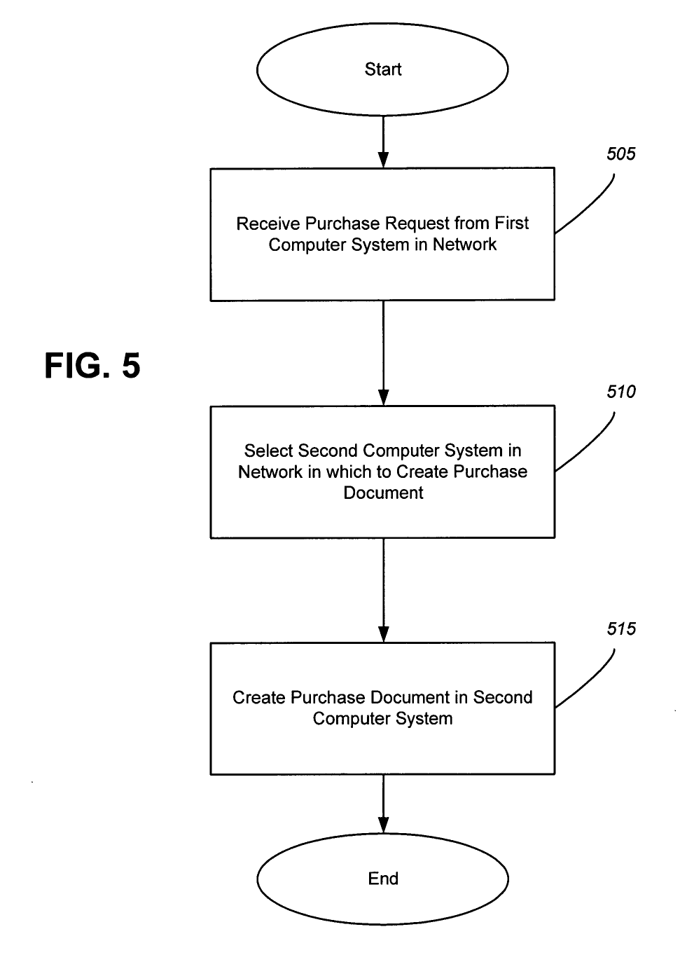

Purchase requests may be represented as objects in the purchasing hub application 235. The purchase requests may share a similar format 400, such as that shown in FIG. 4. A purchase request may include a header 405, and one or more line items 410, 415, 420, etc. The header 405 may include general information about the purchase request, such as a purchase profile, classification, terms and conditions. Each line item 410, 415, 420, etc., describes a good or service to be purchased, and can include an item category identifier 425, a procurement criterion 430, one or more dynamic attributes 435 and one or more attachments 440.

The purchasing hub application 235 can use the item category identifier 425, which would typically be defined when the purchase request is created, to determine the system 105 or 110 in which to create a purchase document by referencing the item category list from the supply source repository 245. The item category identifier 425 may contain an entry representing a generic category description such as “computer,” “office desk,” or “printer” (or analogous numeric entries) corresponding to the desired item to be purchased.

The procurement criterion 430 is a directive to the purchasing hub application 235. Examples of procurement criterion entries can include “Always Source Requirement,” “Never Source Requirement,” and “Create a Bidding Document if No Source of Supply is Available in the System.” An “Always Source Requirement” entry indicates that the purchasing hub application 235 should conduct a search for an acceptable source of supply, such as by searching supply source repository 245 or repositories (not shown) located at EBS's 110. A “Never Source Requirement” entry indicates that the purchase request contains a suggested source of supply, so that a search is unnecessary. In this case, the purchasing hub application 235 may directly create a purchase order at an appropriate system 105 or 110.

A “Create a Bidding Document if No Source of Supply is Available in the System” procurement criterion entry indicates that the purchasing hub application 235 should automatically (that is, without user intervention) create a bidding document for initiating an auction if no suitable sources of supply are available in the system. This may be appropriate, for example, when the desired item has never previously been procured by the business, following a new supplier's entrance into the market, or in situations where a bidding competition among suppliers is likely to result in a more favorable purchase price. In some implementations, the item category identifier 425, in combination with the procurement criterion 430, can be used to determine an appropriate source of supply to fulfill the purchase request and an appropriate system in which to create a purchase document.

Line items can further include (not shown) a product number, a description of the desired good or service, a desired quantity, a price field, and the system from which the request originated. Dynamic attributes 435 are essentially additional fields that can be used to customize a line item in the purchase request for the requestor's particular needs or industry, and can be added to provide additional information. Attachments 440 can be of any file type and can be added to the line item.

Referring again to FIG. 3, a group purchase requests module 315 can group the purchase requests into a working list. This working list can specify all of the purchase requests to be processed by the purchaser's purchasing group, and may be presented to a user on display device 215, for example. A splitting function may be applied to the working list to segment the list, such that a single purchase document can be created to fulfill multiple purchase requests. Splitting may be done according to item category identifier 425, procurement criterion 430, originating system, suggested supplier, or any other line item 410, 415, 420, etc., or dynamic attribute 435 category, including various logical combinations of the same. In this manner, the business may qualify for preferred pricing from suppliers due to high volume orders resulting from combining multiple purchase requests. Similarly, a purchase request for multiple items may be partitioned, such that several purchase documents can be created to fulfill the request.

The purchasing hub application 235 can select an appropriate system in which to create a purchase document, and can identify an appropriate source of supply capable of fulfilling the purchase request. A procurement module 320 performs a procurement process to identify a supplier capable of satisfactorily fulfilling the purchase request. This procurement process can vary depending on the particular procurement criterion 430 associated with the purchase request, as discussed above.

A create purchase document module 325 can create a purchase document, such as a purchase order or a contract, in client computer systems at the purchasing hub system 105 or at any of the EBS's 110, or alternatively can create a bidding document to initiate an auction from the bidding engine application 240. It is possible to create purchase documents at a computer system different from the system that initiated the corresponding purchase request. As such, the system widens the array of supply sources, resulting in better pricing, better access to hard-to-find or limited production items, and a more efficient procurement system. Moreover, a given purchase document can fulfill multiple purchase requests, including requests from multiple EBS's 110 (and/or purchasing hub system 105). Alternatively, a purchase document may only partially fulfill a given purchase request, e.g., a purchase order to procure half of the requested quantity. Selecting supply sources and creating purchase documents without any user intervention can increase the speed at which purchase requests can be processed, and avoid human errors caused by negligence or carelessness.

Purchase orders can also reference contracts. For example, a contract with a given supplier to purchase a predetermined number of items over a predetermined period of time may already exist. The purchasing hub application 235 may locate this contract, a purchase order to procure a fraction of the items may be created, and the contract may be updated to reduce the outstanding order quantity.

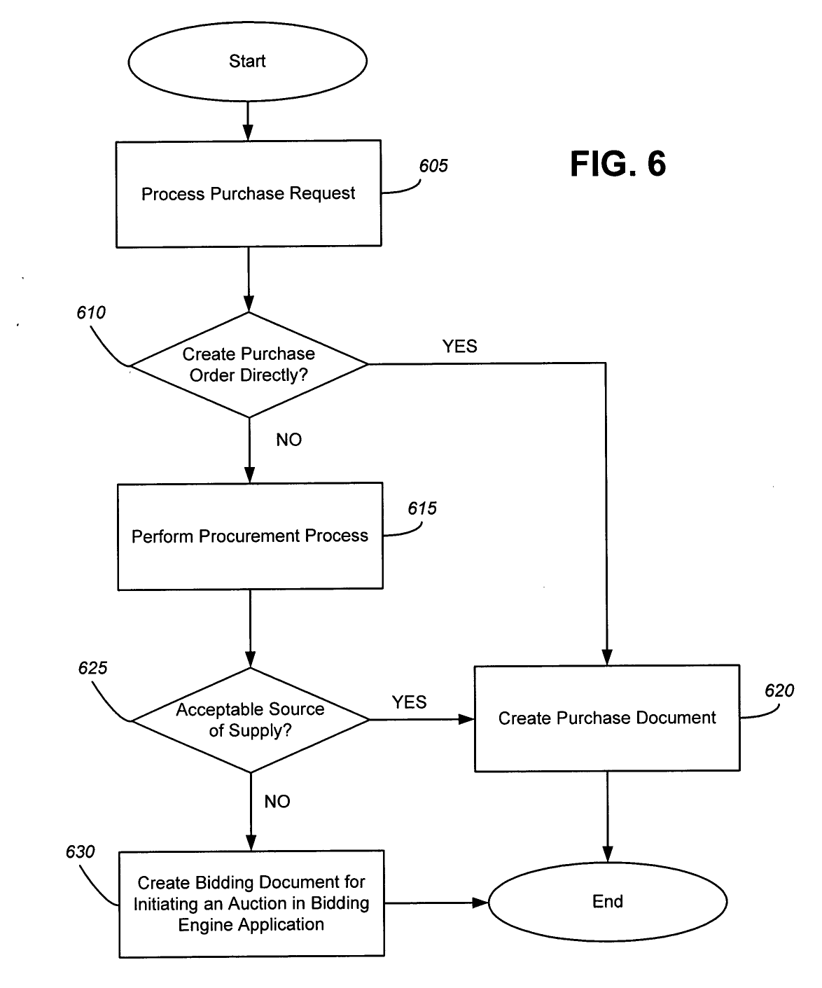

The flowcharts of FIGS. 5-6 show examples of processes that the purchasing hub application 235 may perform. For purposes of discussion, the following description references procuring products; however, it applies to procuring services as well. With reference to FIG. 5, a process begins, at step 505, with the receipt of a purchase request (such as purchase request 400) from a first computer system (such as a computer system at purchasing hub system 105 or at an EBS 110) in a network of computer systems. The purchase request may include an item category identifier (such as item category identifier 425).

The process continues, at step 510, with selecting a second computer system in the network in which to create a purchase document. This may involve using the item category identifier 425 from the received purchase request 400 and referencing the item category identifier list from the supply source repository 245, which list may indicate an appropriate system corresponding to the item category identifier 425. Alternatively, it may involve searching for an appropriate source of supply, for example, from supply repositories at purchasing hub system 105 or EBS 110 and selecting the relevant system. As another example, it may involve selecting a computer system associated with a source of supply specified by the purchase request, or selecting a system associated with a source of supply from a winning auction bid.

Next, at step 515, the purchasing hub application 235 creates a purchase document (such as a purchase order, a contract, or a bidding document) in the second computer system, which was selected in step 510. The purchasing hub application 235 may update a repository (such as repository 245) with the details of the procurement activity, and the process ends.

With reference to FIG. 6, a procurement activity process begins, at step 605, with processing a purchase request (such as purchase request 400). This may involve considering a procurement criterion 430 contained in the request. If, at step 610, the procurement criterion 430 specifies that a purchase order be created directly, a purchase document (such as a purchase order) is created (620) and the process ends. Otherwise, a procurement process is performed at step 615 to identify an appropriate source of supply to fulfill the purchase request. This may involve an automated search of supply source repositories, such as repository 245 or repositories (not shown) located at an EBS 110. Alternatively, a purchasing administrator can manually search for an acceptable source of supply.

If an acceptable source of supply has been located at step 625, a purchase document (such as a purchase order or contract) is created (620) and the process ends. If not, the purchasing hub application 235 can create a bidding document for initiating an auction in the bidding engine application 240 at step 630. Alternatively, if the purchaser is not satisfied with the source of supply search results, an auction may be initiated. The results of the auction may identify a suitable source of supply, a purchase order or contract may be created, and the process ends.

The particular embodiments discussed above are merely illustrative, and may be modified and reconfigured readily in accordance with the teachings set forth herein. By way of non-limiting example, additional procurement criterion entries are possible and the item category list need not be stored in supply source repository 245. Purchasing hub applications on computer systems at various locations throughout the network could share information, thereby further increasing the efficiency of the procurement activities. The computer systems discussed herein need not be personal computers, but could instead be handheld computing devices, terminals, and the like. Requests for quotations may be generated and sent to supplier sites 115 to solicit offers to supply goods and services, which offers could be stored in the supply source repository 245 to be used in future procurement processes. When the program processes a purchase request and detects an error, an error message can be communicated to the originating site and the purchase request can be rejected. The teachings herein have referenced systems for procuring items, but may also be suited to systems for sourcing items.

A number of embodiments of the invention have been described. Nevertheless, it will be understood that various modifications may be made without departing from the spirit and scope of the invention. Accordingly, other embodiments are within the scope of the following claims.

What is claimed is:

1. A method used in an item procurement process and executed by a central computer system in a distributed network of computer systems, the method comprising:
receiving, at the central computer system, a first purchase request for a first item to be procured, the first purchase request received from a first computer system in the network of computer systems and comprising a first item category identifier that describes the first item;
selecting a second computer system in the network in which to create a purchase document, the selection of the second computer system based on the first item category identifier; and
controlling the creation of the purchase document in the second computer system.

2. The method of claim 1 wherein the second computer system is different from the first computer system.

3. The method of claim 1 wherein the purchase document is a purchase order for the first item.

4. The method of claim 1 wherein the purchase document is a contract for the first item.

5. The method of claim 1 wherein the purchase document is a bidding document for the first item, and wherein a plurality of suppliers are invited to participate in an auction whereby the suppliers bid to source the first item.

6. The method of claim 5 wherein each of the suppliers is associated with one of the computer systems in the network of computer systems, and wherein selecting the second computer system comprises identifying a supplier using results from the auction and selecting the associated computer system.

7. The method of claim 1 wherein the first item is a good.

8. The method of claim 1 wherein the first item is a service.

9. The method of claim 1 further comprising receiving a second purchase request for a second item to be procured, the second purchase request received from a third computer system in the network and comprising a second item category identifier that describes the second item, and wherein the selection of the second computer system in which to create the purchase document is based on the first item category identifier and the second item category identifier.

10. The method of claim 9 wherein the purchase document is a purchase order for the first and second items.

11. The method of claim 1 wherein selecting the second computer system comprises referencing an item category list that contains a plurality of item category identifiers and a corresponding computer system for each item category identifier, and further comprises locating the first item category identifier in the item category list and identifying the corresponding computer system.

12. The method of claim 1 wherein selecting the second computer system is carried out without user intervention.

13. The method of claim 1 wherein a user manually selects the second computer system.

14. The method of claim 1 further comprising identifying a supplier to fulfill the first purchase request.

15. The method of claim 14 wherein identifying a supplier comprises searching supply source repositories located on a plurality of computer systems in the distributed network of computer systems.

16. The method of claim 1 wherein the first purchase request identifies a suggested supplier to fulfill the first purchase request.

17. The method of claim 16 wherein the second computer system is the same as the first computer system.

18. The method of claim 1 wherein the first purchase request further comprises a procurement criterion that is a directive for the item procurement process, and wherein the selection of the second computer system is based on the procurement criterion.

19. The method of claim 18 wherein the procurement criterion is selected from a group consisting of “Always Source Requirement,” “Never Source Requirement,” and “Create a Bidding Document if No Source of Supply is Available in the System.”

20. A computer system for controlling a procurement process in a distributed network of computer systems, the computer system comprising:
a purchasing hub module programmed to:
(a) receive a first purchase request for a first item to be procured, the first purchase request received from a first computer system in the network of computer systems and comprising a first item category identifier that describes the first item;
(b) select a second computer system in the network in which to create a purchase document, the selection of the second computer system based on the first item category identifier; and
(c) control the creation of the purchase document in the second computer system.

21. The computer system of claim 20 further comprising a bidding engine module programmed to initiate an auction whereby a plurality of suppliers are invited to bid to source the first item.

22. The computer system of claim 21 wherein the purchase document is a bidding document for the first item, and wherein the bidding engine module uses the bidding document to initiate the auction.

23. The computer system of claim 22 wherein each of the suppliers is associated with one of the computer systems in the network of computer systems, and wherein selecting the second computer system comprises identifying a supplier using results from the auction and selecting the associated computer system.

24. The computer system of claim 20 wherein the second computer system is different from the first computer system.

25. The computer system of claim 20 wherein the purchase document is a purchase order for the first item.

26. The computer system of claim 20 wherein the purchase document is a contract for the first item.

27. The computer system of claim 20 wherein the first item is a good.

28. The computer system of claim 20 wherein the first item is a service.

29. The computer system of claim 20 further comprising the purchasing hub module being programmed to receive a second purchase request for a second item to be procured, the second purchase request received from a third computer system in the network and comprising a second item category identifier that describes the second item, and wherein the selection of the second computer system in which to create the purchase document is based on the first item category identifier and the second item category identifier.

30. The computer system of claim 29 wherein the purchase document is a purchase order for the first and second items.

31. The computer system of claim 20 wherein selecting the second computer system comprises referencing an item category list that contains a plurality of item category identifiers and a corresponding computer system for each item category identifier, and further comprises locating the first item category identifier in the item category list and identifying the corresponding computer system.

32. The computer system of claim 20 wherein selecting the second computer system is carried out without user intervention.

33. The computer system of claim 20 wherein a user manually selects the second computer system.

34. The computer system of claim 20 further comprising the purchasing hub module being programmed to identify a supplier to fulfill the first purchase request.

35. The computer system of claim 34 wherein identifying a supplier comprises searching supply source repositories located on a plurality of computer systems in the distributed network of computer systems.

36. The computer system of claim 20 wherein the first purchase request identifies a suggested supplier to fulfill the first purchase request.

37. The computer system of claim 36 wherein the second computer system is the same as the first computer system.

38. The computer system of claim 20 wherein the first purchase request further comprises a procurement criterion that is a directive for the item procurement process, and wherein the selection of the second computer system is based on the procurement criterion.

39. The computer system of claim 38 wherein the procurement criterion is selected from a group consisting of “Always Source Requirement,” “Never Source Requirement,” and “Create a Bidding Document if No Source of Supply is Available in the System.”
